(19) United States
(12) Patent Application Publication
(10) Pub. No.: US 2009/0138115 A1
(43) Pub. Date: May 28, 2009

(54) INTELLIGENT OPTIMIZATION METHOD AND SYSTEM THEREFOR

(75) Inventors: Yung C. Shin, West Lafayette, IN (US); Cheol W. Lee, Birmingham, MI (US)

Correspondence Address: HARTMAN & HARTMAN, P.C., 552 EAST 700 NORTH, VALPARAISO, IN, 46383, US

(73) Assignee: PURDUE RESEARCH FOUNDATION, West Lafayette, IN (US)

(21) Appl. No.: 12/323,972

(22) Filed: Nov. 26, 2008

Related U.S. Application Data
(60) Provisional application No. 60/990,431, filed on Nov. 27, 2007.

(51) Int. Cl. G05B 13/04; G06F 15/18; G06F 19/00; G06N 3/12

(52) U.S. Cl. 700/104; 706/12; 700/164; 706/13

(57) ABSTRACT

A method and system of optimizing a complex manufacturing process performed by an apparatus on a subject to achieve at least one processing objective. The system includes a graphical user interface, a process module, and an optimization module. The process module includes a training module, an empirical relationships database, an analytical equations database, a heuristic knowledge database, and a process models database. The graphical user interface is used to input at least one processing variable and constraints for the processing objective of the complex manufacturing process. The training module generates empirical relationships from the processing variable and empirical data obtained from the complex manufacturing process. The process module generates a process model that takes into consideration heuristic knowledge of the complex manufacturing process stored in the heuristic knowledge database, empirical relationships stored in the empirical relationships database, and optionally analytical equations stored in the analytical equations database and relating to the complex manufacturing process. The optimization module employs the process model to optimize the complex manufacturing process.

### CROSS REFERENCE TO RELATED APPLICATIONS

This application claims the benefit of U.S. Provisional Application No. 60/990,431, filed Nov. 27, 2007, the contents of which are incorporated herein by reference.

### BACKGROUND OF THE INVENTION

The present invention generally relates to methods and systems for optimizing complex manufacturing processes, such as grinding processes, to achieve various objectives, such as cost minimization, productivity maximization, and process control.

### BRIEF SUMMARY OF THE INVENTION

The present invention generally provides a method for model-based optimization of complex problems with constraints, such as encountered when attempting to optimize complex manufacturing processes such as various forms of grinding. The method utilizes heterogeneous domains of information existing in the forms of analytical equations, data, and heuristic knowledge, and performs optimization for various objective functions. The method employs a soft computing technique for optimization and a self-learning scheme of unknown nonlinear systems. The method is capable of handling mixed integer problems, i.e., both continuous and discrete variables, at the same time while satisfying all the constraints imposed thereon. Therefore, the method provides the capability of providing guaranteed global optimal solutions for many different types of optimization problems.

This invention provides the capabilities of learning from experimental data and combining them with mathematical models. In addition, the invention provides a computationally efficient and guaranteed optimal solution for mixed integer optimization problems with constraints. The technology also allows for learning of complex systems by means of an autonomous learning scheme and using them in the optimization.

Other objects and advantages of this invention will be better appreciated from the following detailed descriptions.

### DETAILED DESCRIPTION OF THE INVENTION

T. Choi and Y. C. Shin, “Generalized Intelligent Grinding Advisory System,” International Journal of Production Research, 2006, 1-34, preview article (subsequently published as T. Choi and Y. C. Shin, “Generalized Intelligent Grinding Advisory System,” International Journal of Production Research, Vol. 45, No. 8, pp. 1899-1932, April 2007)), is attached hereto, and the contents thereof are incorporated herein by reference as the Detailed Description of the Invention.

While the invention is disclosed and described herein in terms of specific embodiments, it will be apparent that other forms could be adopted by one skilled in the art. Accordingly, it should be understood that the invention is not limited to the specific embodiments described and illustrated in the detailed descriptions. It should also be understood that the phraseology and terminology employed above are for the purpose of disclosing the embodiments, and do not necessarily serve as limitations to the scope of the invention. Instead, the scope of the invention is to be limited only by the following claims.

1. A method of optimizing a complex manufacturing process performed on a subject to achieve at least one processing objective, the method comprising the steps of:
providing a system comprising a graphical user interface, a process module in communication with the graphical user interface, and an optimization module in communication with the process module, the process module comprising a training module, an empirical relationships database, an analytical equations database, a heuristic knowledge database, and a process models database, the system controlling an apparatus adapted to perform the complex manufacturing process;
using the graphical user interface to input into the system at least one processing variable and constraints for the at least one processing objective of the complex manufacturing process;
operating the apparatus to perform a trial of the complex manufacturing process on a specimen of the subject using the at least one processing variable;
inputting the at least one processing variable used in the trial and empirical data from the trial into the training module, the training module generating at least one empirical relationship between the at least one processing variable used in the trial and the empirical data from the trial and storing the at least one empirical relationship in the empirical relationships database;
using the process module to generate a process model that takes into consideration heuristic knowledge of the complex manufacturing process stored in the heuristic knowledge database, the at least one empirical relationship stored in the empirical relationships database, and optionally analytical equations stored in the analytical equations database and relating to the complex manufacturing process;
storing the process model in the process models database; and
operating an optimization module by which the process model is employed to optimize the complex manufacturing process by adjusting the at least one processing variable and inputting the adjusted processing variable into the apparatus before again operating the apparatus to perform the complex manufacturing process.

2. The method according to claim 1, wherein the complex manufacturing process is a grinding operation chosen from the group consisting of surface grinding, cylindrical plunge grinding, cylindrical traverse grinding, centerless grinding, and internal grinding.

3. The method according to claim 2, wherein the at least one processing variable comprises the grinding operation, operating parameters of a grinding machine therefor, and material of the subject.

4. The method according to claim 1, wherein the at least one processing objective is chosen from the group consisting of cost of the complex manufacturing process, cycle time of the complex manufacturing process, and desired properties of the subject following the complex manufacturing process.

5. The method according to claim 4, wherein the complex manufacturing process is a grinding operation and the desired properties include at least one property chosen from the group consisting of surface roughness, residual stress, and out-of-roundness of the subject.

6. The method according to claim 1, wherein the optimization engine employs an evolutionary strategies (ES) algorithm.

7. The method according to claim 1, wherein the training module employs an RBFN model to generate the at least one empirical relationship from the at least one processing variable and the empirical data.

8. The method according to claim 1, wherein the process module employs an FBFN or RBFN model to generate the process model from the heuristic knowledge stored in the heuristic knowledge database and the at least one empirical relationship stored in the empirical relationships database.

9. The method according to claim 1, wherein the process module further comprises a machine database containing operational information of the apparatus.

10. A system for optimizing a complex manufacturing process performed by an apparatus on a subject to achieve at least one processing objective, the system comprising:
a graphical user interface operable to input into the system at least one processing variable and constraints for the at least one processing objective of the complex manufacturing process;
a process module in communication with the graphical user interface, the process module comprising a training module, an empirical relationships database, an analytical equations database, a heuristic knowledge database, and a process models database, the training module being operable to generate at least one empirical relationship between the at least one processing variable and empirical data and store the at least one empirical relationship in the empirical relationships database, the process module being operable to generate a process model that takes into consideration heuristic knowledge of the complex manufacturing process stored in the heuristic knowledge database, the at least one empirical relationship stored in the empirical relationships database, and optionally analytical equations stored in the analytical equations database and relating to the complex manufacturing process, the process module being further operable to store the process model in the process models database; and
an optimization module in communication with the process module, the optimization module being operable to employ the process model to optimize the complex manufacturing process by adjusting the at least one processing variable and inputting the adjusted processing variable into the apparatus.

11. A system for optimizing a complex manufacturing process performed on a subject to achieve at least one processing objective, the system comprising:
means for inputting constraints for the at least one processing objective into an apparatus adapted to perform the complex manufacturing process;
means for inputting into the apparatus at least one processing variable of the complex manufacturing process;
means for operating the apparatus to perform a trial of the complex manufacturing process on a specimen of the subject using the at least one processing variable;
means for inputting the at least one processing variable used in the trial and empirical data from the trial into a training module, the training module generating at least one empirical relationship between the at least one processing variable used in the trial and the empirical data from the trial, the training module storing the at least one empirical relationship in a empirical relationships database;
a process model that takes into consideration analytical equations relating to the complex manufacturing process, heuristic knowledge of the complex manufacturing process stored in a heuristic knowledge database, and the at least one empirical relationship from the training module; and
an optimization engine by which the process model is employed to optimize the complex manufacturing process by adjusting the at least one processing variable and inputting the adjusted processing variable into the apparatus before again operating the apparatus to perform the complex manufacturing process.

12. The system according to claim 11, wherein the complex manufacturing process is a grinding operation chosen from the group consisting of surface grinding, cylindrical plunge grinding, cylindrical traverse grinding, centerless grinding, and internal grinding.

13. The system according to claim 12, wherein the at least one processing variable comprises the grinding operation, operating parameters of a grinding machine therefor, and material of the subject.

14. The system according to claim 11, wherein the at least one processing objective is chosen from the group consisting of cost of the complex manufacturing process, cycle time of the complex manufacturing process, and desired properties of the subject following the complex manufacturing process.

15. The system according to claim 14, wherein the complex manufacturing process is a grinding operation and the desired properties include at least one property chosen from the group consisting of surface roughness, residual stress, force, power, grinding ratio, and out-of-roundness of the subject.

16. The system according to claim 11, wherein the means for inputting the at least one processing objective and the at least one processing variable are components of a graphical user interface.

17. The system according to claim 11, wherein the optimization engine employs an extended evolutionary strategies (ES) algorithm.

18. The system according to claim 11, wherein the training module employs an RBFN model to generate the at least one empirical relationship from the at least one processing variable and the empirical data.

19. The system according to claim 11, wherein the process module employs an FBFN or RBFN model to generate the process model from the heuristic knowledge stored in the heuristic knowledge database and the at least one empirical relationship stored in the empirical relationships database.

20. The system according to claim 11, wherein the process module further comprises a machine database containing operational information of the apparatus.
